(19) United States
(12) Patent Application Publication
(10) Pub. No.: US 2017/0273238 A1
(43) Pub. Date: Sep. 28, 2017

(54) Vegetation Clearing Implements

(71) Applicant: Jeffrey Ryan Penner, Swan River (CA)

(72) Inventor: Jeffrey Ryan Penner, Swan River (CA)

(21) Appl. No.: 15/451,915

(22) Filed: Mar. 7, 2017

Related U.S. Application Data
(60) Provisional application No. 62/312,820, filed on Mar. 24, 2016.

(51) Int. Cl. A01D 34/01; A01G 23/08

(52) U.S. Cl. CPC A01D 34/015; A01G 23/08

(57) ABSTRACT

A vegetation clearing implement features at least one blade arranged for conveyance over an area of land in a forward working direction. Each blade features a respective serrated cutting edge positioned at a leading side of the blade. The serrated cutting edge lies along an oblique axis that resides at an oblique angle to the forward working direction. The serrated cutting edge features alternating crests and troughs situated along the oblique axis, and each trough has a concave curvature between a pair of adjacent crests. A slope of the concave curvature at its leading end is more parallel to the forward working direction than its trailing end. This provides a gradual increase in the aggression of cut as the equipment moves through the vegetative material to provide for smooth, efficient travel of the implement during a vegetation clearing operation.

### CROSS REFERENCE TO RELATED APPLICATIONS

This application claims benefit under 35 U.S.C. 119(e) of Provisional Application Ser. No. 62/312,820, filed Mar. 24, 2016, the entirety of which is incorporated herein by reference.

### FIELD OF THE INVENTION

The present invention relates generally to vegetation clearing equipment, and more particularly to vegetation clearing equipment employing serrated cutting edges carried at oblique angles to a travel direction of the equipment and employing a serration pattern providing a gradual increase in the aggression of cut as the equipment moves through the vegetative material, unique removable mounting of the serrated cutting edges, and non-inclined upper blade areas to prevent undesirable blade lift.

### BACKGROUND

It is known to use serrated, toothed or beveled cutting edges carried close to ground level at the lower ends of blades mounted to the front of bulldozers or other working machines for the purpose of clearing trees and other vegetation, for example as shown in U.S. Pat. Nos. 2,633,164, 2,821,217, 3,081,564, 3,557,850, 3,415,296, 5,687,784. U.S. Pat. No. 4,010,805 teaches attachment of a V-shaped implement with rearwardly diverging blades at the rear end of a bulldozer for pulling of the blade through the earth at a subsurface location to clear brush. U.S. Pat. No. 3,160,215 teaches a front-mounted bulldozer attachment with a beveled blade operated below the surface to cut roots, stumps or other subsurface objects. U.S. Pat. No. 7,610,698 discloses a skid-steer attachment with a knife-like tip for penetrating into the earth and extracting the root system of a tree or other plant therefrom.

U.S. Pat. Nos. 2,821,217 and 3,415,296 disclose that their serrated V-shaped blade configurations providing an effective step-by-step cutting action by which the working machine can gain traction and maintain momentum during the time that contact with a tree slips from one serration to the next, and reduce the tendency for the implement to simply skip laterally off a tree under impact of a straight, non-serrated edge therewith.

Applicant has developed new vegetation clearing implement which, among other novel features, includes a unique serration pattern on one or more angled blades that not only prevents such lateral skipping of the machine upon impact of a tree, but also provides a gradual increase in the aggression of the cutting action through each serration, thereby smoothing out the forward travel momentum of the implement.

Other unique and advantageous features include lack of an overhanging or inclined upper blade area on which cleared vegetative material may push the blade upwardly out of an optimal cutting position, and a unique bolt-on mounting solution for the removable cutting blades.

### SUMMARY OF THE INVENTION

According to a first aspect of the invention, there is provided a vegetation clearing implement comprising:

at least one blade arranged for conveyance over an area of land in a forward working direction and each comprising a respective serrated cutting edge positioned at a leading side of the blade to ride over the ground area in close relation thereto, the serrated cutting edge of each blade lying along an oblique axis that resides at an oblique angle relative to said forward working direction;

wherein the serrated cutting edge comprises alternating crests and troughs situated along the oblique axis and has a concave curvature at each trough disposed between a pair of adjacent crests, the concave curvature has a leading end that joins to a leading one of said adjacent crests and a trailing end that joins to a trailing one of said adjacent crests, a slope of the concave curvature is more parallel to the forward working direction at the leading end than at the trailing end, and the slope of the concave curvature at the leading end is within fifteen degrees of parallel to the forward working direction.

In one embodiment, the concave curvature spans peak to peak from said leading crest to said trailing crest.

In one embodiment, the slope at the trailing end of the concave curvature is within fifteen degrees of perpendicular to the forward working direction.

Preferably, relative to a respective longitudinal reference axis that is parallel to the forward working direction and intersects the leading end of the concave curvature at any trough, the slope of the leading end of the concave curvature at said trough is sloped at an acutely oblique angle to said reference axis on a same side thereof as the trailing end of the concave curvature of said trough.

Preferably, relative to a lateral reference axis that is perpendicular to the forward working direction and intersects the trailing end of the concave curvature at any trough, the slope of the trailing end of the concave curvature at said trough is sloped at an acutely oblique angle to said lateral reference axis on a same side thereof as the leading end of the concave curvature at said trough.

Preferably the concave curvature at each trough of the serration pattern is arcuate in shape.

Preferably the concave curvature of each trough of the serration pattern is uniform in radius.

Preferably each trough of the serration pattern is symmetric about a bisecting midline that resides centrally between the peaks of the adjacent crests.

Preferably the peaks of the crests all reside on the oblique axis.

Preferably wherein the cutting edge comprises a chamfer at the troughs and the crests, said chamfer leaving an unbeveled strip at a bottom of each trough.

Preferably wherein each blade has a curved lower portion which curves upwardly away from the cutting edge and an upper portion spanning upward from the curved lower portion to a top end of the blade, and the upper portion, on the leading side of the blade, is free of any inclination toward said leading side of the blade.

Preferably the upper portion of each blade is vertically oriented.

Preferably each blade comprises a clearing panel that defines a face of the blade and has a curved lower area at the lower portion of the blade and a flat upper area that resides at the upper portion of the blade and reaches the top end thereof.

Preferably the serrated cutting edge of each blade is at least partially defined by a cutting edge member bolted to a remainder of the blade via a set of bolt holes provided in the cutting member in positions trailing the serrated cutting edge.

Preferably a mounting plate affixed to the curved lower end of the clearing panel has a corresponding set of bolt holes therein by which the cutting edge member is bolted to the mounting plate.

Preferably the cutting edge member is bolted to an underside of the mounting plate, and a trailing edge of the cutting member abuts against a stop shoulder that is situated behind the corresponding set of bolt holes in the mounting plate and serves to align the bolt holes of the cutting edge member with the corresponding set of bolt holes in the mounting plate.

Preferably the set of bolt holes in the cutting edge member comprise countersunk lower ends at an underside of the cutting edge member for accommodating bolt heads in non-protruding positions relative to said underside of the cutting edge.

In one embodiment, the at least one blade comprises a pair of diverging blades that meet at an apex at a leading end of the implement.

In one embodiment, the serrated cutting edges of the pair of diverging blades are partially defined by respective cutting edge members that terminate short of one another at the apex and partially defined by a separate front cutting edge unit that is mounted between the cutting edge members at the apex, the front cutting edge unit having serrations on adjacent diverging sides thereof that meet at a leading tip of said front cutting edge and align with corresponding serrations on the cutting edge members so that the serrations of the cutting edge unit and the corresponding serrations of the cutting edge members collectively define the serrated cutting edges of the diverging blades.

Preferably the front cutting edge unit is bolted to the mounting plates of the diverging blades at a location between the cutting edge members at the apex.

Preferably the serrations of the front cutting edge unit and the corresponding serrations of the cutting edge members are matching serrations.

Preferably each crest of the serration pattern is bisected by a respective bisection axis that lies perpendicular to the oblique axis.

Preferably wherein the peak of each crest of the serration pattern has a ridge at which sloped faces of adjacent troughs on opposite sides of said crest directly intersect, and a flat lower tip face that resides beneath the upper ridge and tapers upwardly theretoward.

Preferably the implement comprises a frame conveyable in the forward working direction, the at least one blade being carried on said frame and the respective serrated cutting edge of each blade being carried at a lower end of said blade in the close elevation to said ground area.

In one embodiment, the implement is an attachment implement, the frame of which is selectively attachable to a working machine at a leading end thereof for conveyance of said attachment implement by driving of said working machine in the forward working direction.

In another embodiment, the implement is a towed implement comprising a pull tongue connected to the frame and reaching forwardly therefrom for connection to a tow vehicle driveable in the forward working direction to pull said towed implement in said forward working direction.

Preferably the tow vehicle carries another blade-equipped vegetation clearing arrangement at a leading end of said tow vehicle, the towed implement having an implement working width measured transversely of the forward working direction that exceeds a working width of the tow vehicle.

In one embodiment, the blade-equipped vegetation clearing arrangement of the tow vehicle comprises at least one vehicle-carried blade of a same type as the at least one blade of the vegetation clearing implement.

The at least one vehicle-carried blade may comprise a pair of diverging blades that meet at a leading end of the blade-equipped vegetation clearing arrangement at the leading end of the tow vehicle.

According to a second aspect of the invention, there is provided a vegetation clearing implement comprising:

at least one blade arranged for conveyance over an area of land in a forward working direction and each comprising a respective serrated cutting edge positioned at a leading side of the blade to ride over the ground area in close relation thereto, the serrated cutting edge of each blade lying along an oblique axis that resides at an oblique angle relative to said forward working direction;

wherein the serrated cutting edge comprises alternating crests and troughs situated along the oblique axis, and at each trough disposed between a pair of adjacent crests, the serrated cutting edge follows a concave curvature spanning peak to peak from one of said adjacent crests to the other.

Preferably each adjacent pair of crests comprises a respective leading crest and a respective trailing crest, of which the leading crest leads the trailing crest in the forward working direction, the concave curvature has a leading end at the leading crest and a trailing end at the trailing crest, and a slope of the concave curvature is more parallel to the forward working direction at the leading end than at the trailing end.

Preferably the slope at the leading end is within fifteen degrees of parallel to the forward working direction.

According to a third aspect of the invention, there is provided a method of clearing vegetation from an area of land, the method comprising:

providing a tow vehicle having a first vegetation-clearing blade arrangement at a leading of said tow vehicle, said first vegetation-clearing blade arrangement having a first working width measured perpendicularly transverse to a forward travel direction of said tow vehicle;

providing a towed implement having a second vegetation-clearing blade arrangement carried thereon, said second vegetation-clearing blade arrangement having a second working width that is measured perpendicularly transverse to the forward travel direction of said tow vehicle and exceeds the first working width;

with the towed implement connected to the tow vehicle in a trailing position therebehind with a portion of the towed implement's second working width situated outwardly beyond the first working width of the tow vehicle, towing the implement in the forward travel direction in one or more passes over the area of land.

In one embodiment, the second vegetation-clearing blade arrangement comprise diverging blades on opposite sides thereof which reach outwardly beyond both ends of the first working width, and the step of towing the implement in one or more passes comprises performing a first pass in which both of the diverging blades clear vegetation from a strip of land.

In such instance, the method may include performing a subsequent pass in which one of the diverging blades performs further clearing of an adjacent strip of land residing alongside the strip of land that was cleared in the first pass, while the other one of the diverging blades passes over the same strip of land that was cleared in the first pass.

According to a fourth aspect of the invention, there is provided a vegetation-clearing system comprising:

a tow vehicle having a first vegetation-clearing blade arrangement at a leading of said tow vehicle, said first vegetation-clearing blade arrangement having a first working width measured perpendicularly transverse to a forward travel direction of said tow vehicle; and

a towed implement having a second vegetation-clearing blade arrangement carried thereon, said second vegetation-clearing blade arrangement having a second working width that is measured perpendicularly transverse to the forward travel direction of said tow vehicle and exceeds the first working width, and said second vegetation-clearing blade arrangement being connectable to the tow vehicle in a position trailing therebehind with a portion of the towed implement's second working width situated outwardly beyond the first working width of the tow vehicle.

According to a fifth aspect of the invention, there is provided a vegetation clearing implement comprising:

at least one blade comprising:
a cutting edge member having a cutting edge and a set of bolt holes passing through the cutting member at an area thereof between the cutting edge and an opposing perimeter edge of the cutting edge member;
a clearing panel that defines a face of the blade and has a curved lower area curving upwardly away from the cutting edge member at a lower portion of the blade; and
a mounting plate affixed to the curved lower end of the clearing panel and having a corresponding set of bolt holes therein by which the cutting edge member is bolted to the mounting plate in a position placing the cutting edge of the cutting edge member outwardly beyond both the mounting plate and the curved lower area of the clearing panel on a leading side of the panel faced by a concave side of the curved lower area of the clearing panel.

According to a sixth aspect of the invention, there is provided a vegetation clearing implement comprising:

at least one blade comprising:
a cutting edge mounted at a lower portion of the blade on a leading side thereof for riding over the ground in close proximity thereto;
a curved lower portion which curves upwardly away from the cutting edge with a concave side of the curved lower portion facing said leading side of the blade; and
an upper portion spanning upward from the curved lower portion to a top end of the blade;

wherein the upper portion of the blade is free of any inclination toward the leading side of the blade.

### BRIEF DESCRIPTION OF THE DRAWINGS

One embodiment of the invention will now be described in conjunction with the accompanying drawings in which:

FIG. 1 is a perspective view of a V-wing implement on which serrated cutting edges of the present invention may be employed on its front and rear blade sections for vegetation clearing purposes, the rear blades sections being shown deployed into lowered working positions.

FIG. 2 is a perspective view of the V-wing implement of FIG. 1 with the rear blade sections retracted into raised transport positions.

FIGS. 3A-3F show perspective, top plan, cross-sectional, end, front and partial closeup views, respectively, of a serrated cutting edge member of the present invention, with FIG. 3C showing the cross-section viewed along line C-C of FIG. 3B and FIG. 3F showing the details of closeup circle F of FIG. 3E.

FIGS. 4A-4E show perspective, rear, top plan, end, and partial closeup views, respectively, of a blade structure on which the serrated cutting edge member of FIG. 3 may be used.

FIG. 5A is an overhead plan view of an assembled V-shaped configuration of diverging blades assembled from blade structures and serrated cutting edge members of the types shown in FIGS. 3 and 4, together with a serrated front cutting edge unit installed at the apex of the diverging blades.

FIG. 5B is an overhead plan view of the cutting edge members and front cutting edge unit of FIG. 5A in isolation.

FIG. 5C is a partial closeup view of the cutting edge members and front cutting edge unit of FIG. 5B, and illustrates the geometry of a cutting edge serration pattern thereof with reference to a forward working direction in which the implement is conveyed during use.

FIG. 6 is an overhead plan view illustrating use of serrated blades of the present invention on both a working machine and an accompanying towed implement pulled thereby in order to clear a wider swath of land in a single pass compared to use of the working machine alone.

In the drawings like characters of reference indicate corresponding parts in the different figures.

### DETAILED DESCRIPTION

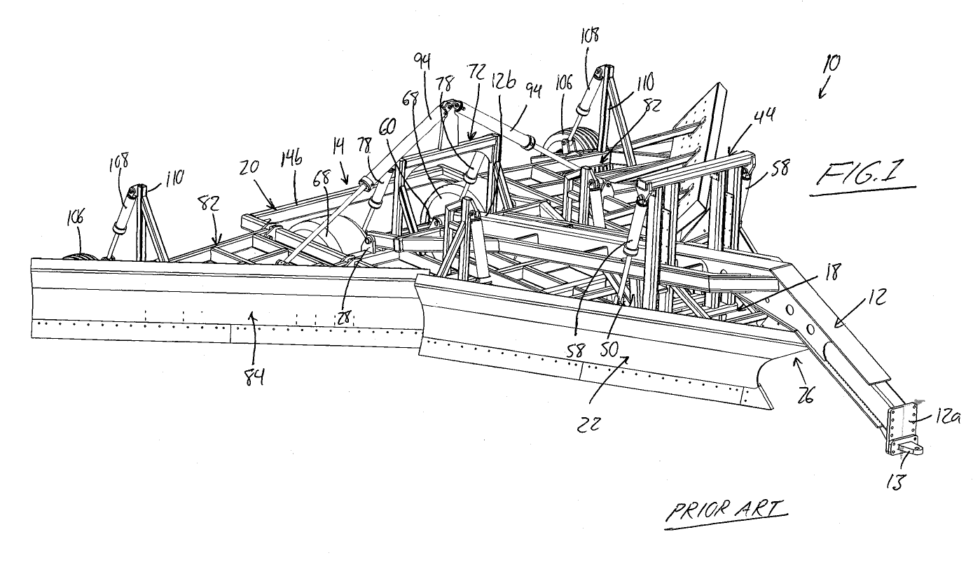

FIGS. 1 and 2 illustrate a V-wing implement of the type disclosed in Applicant's U.S. Patent Application Publication No. 2014/0331527, the entirety of which is incorporated herein by reference, and on which the ditching blades described in said publication may be replaced with blades of the present invention to adapt the implement for clearing vegetation from an area of land.

The implement 10 is configured as a towable implement having a pull tongue 12 equipped at its front or leading end 12a with suitable hitch connection features 13 for coupling the pull tongue 12 to the hitch of a suitable towing vehicle. At a distance back from the tongue's front end 12a, a rigid frame structure 14 of the apparatus lies below the tongue 12, and extends from a leading or front end of the frame 14 located generally below a bend in the tongue 12 to a trailing or rear end 14b of the frame 14 at a distance back from the rear end 12b of the tongue 12. The frame 14 features front and rear portions 18, 20 which are triangular and rectangular in plan, respectively. Front blade sections 22 are fixed to the front frame portion 18 on opposite sides thereof, meeting together at an apex situated ahead of the tip of the front portion 18 at the leading end of the frame.

The tongue 12 features a pivotal connection 28 to the rear frame portion 20 near the frame's rear or trailing end 14b. The pivotal connection 28 between the frame 14 and the pull tongue 12 defines a horizontal pivot axis lying perpendicularly to a longitudinal axis of the implement that extends through the apex of the assembled blade sections and bisects the diverging blade sections on the two sides of the implement frame. Two-way hydraulic actuators 58 have their upper ends connected to an upright structure 44 that stands upward from the front frame section and their lower ends connected to an undercarriage 50 that is affixed to the underside of the pull tongue 12. Accordingly, extending the hydraulic actuators 58 operates to push down on the undercarriage relative to the upright structure 44, thus acting to move the tongue 12 and frame 14 of the apparatus relatively toward one another. With the tongue 12 secured to the hitch of a tow vehicle, this thus acts to raise the front portion 18 of the frame 14, and the blade sections 22 attached thereto, upwardly toward the main longitudinal member 16 of the tongue about the pivot axis defined by the pivotal connection 28 between the frame and tongue. On the other hand, collapsing or retracting the actuators 58 causes relative movement between the frame and tongue in the opposite direction, i.e. moving the front frame section and the tongue longitudinal member 16 relatively away from one another so that the lower the leading end of the frame and the attached front blade sections 22 move away from the tongue's main longitudinal member 16 about the frame/tongue pivot axis near the rear of the machine.

A wheel carrier unit 60 is pivotally attached to the rear frame section for pivoting about a horizontal wheel-pivot axis, and rotatably carries two wheels 68 that reside between opposing parallel sides of the rear frame section 20. A second upright structure 72 stands upright from the rear frame section in front of the wheel carrier unit 60. Two hydraulic actuators 78 each have one end coupled to the second upright structure 72 and the other end coupled to the wheel carrier unit 60 to cause lifting and lowering thereof about its horizontal wheel-pivot axis under collapse and extension of the actuators 78, thereby raising and lowering the wheels 68.

Each front blade section 22 extends from the apex 26 at the leading end of the frame 14 along a respective one of equal length sides of the front frame section 18. On each its sides, the rear frame section 20 pivotally carries a respective triangular sub-frame 82 on which a respective rear blade section 84 is rigidly mounted. Each rear blade section is fixed to a diagonal outer rail of the respective sub-frame 82 so that in a working position intended for use, each rear blade section 84 spans from a position adjacent the rear end of the respective front blade section 22 to a short distance past the rear end of the respective sub-frame 82, whereby the rear blade sections diverge from one another behind the front blade sections to form extension thereof to complete the overall V-shaped configuration of the implement.

To reduce the overall width of the apparatus, for example for roadway transport purposes, the rear blades 84 can be retracted from the deployed working positions of FIG. 1 to the stowed positions of FIG. 2. For this purpose, a respective rear-blade hydraulic actuator 94 is connected between each sub-frame 82 and the rear upright structure 72 for pivotal raising and lowering of the sub-frame about an axis parallel to the longitudinal axis of the frame 14.

Each sub-frame features a respective pivotally mounted wheel carrier 104 rotatably carrying a respective outboard wheel 106. A respective outboard hydraulic actuator 108 for each outboard wheel has one end coupled to an upright 110 on the respective sub-frame and the other end connected to the outboard wheel carrier 104. When the sub-frames and rear blades 84 are deployed for use, the outboard actuator 108 is extended to pivot the wheel carrier downward about its pivotal connection to the sub-frame's rear end until the outboard wheel engages the ground to rollingly support the sub-frame thereon. When the sub-frames and rear blades 84 are raised into the stowed positions, the outboard actuator 108 is retracted to pivot the outboard wheel carrier about its pivotal connection to the sub-frame's rear end cross-member 88 in the opposite direction so as to extend the outboard wheel carrier 104 to the same side of the sub-frame 82 as the upright 110 to avoid or minimize projection of the outboard wheel 106 laterally outward from the stowed sub-frame and rear blade.

Having described one example of a type of V-shaped implement on which unique blades of the present invention may be used in place of the front and rear blade sections 22 and 84, attention is now turned to the details of such blades. It will be appreciated that the unique blades may additionally or alternatively be used on other implements, whether towed or self-conveying, or V-shaped or otherwise.

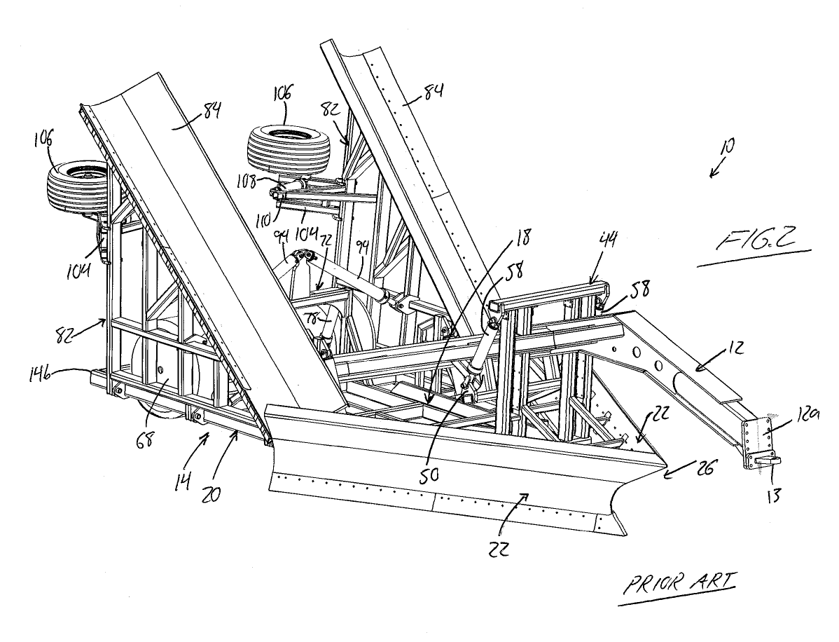

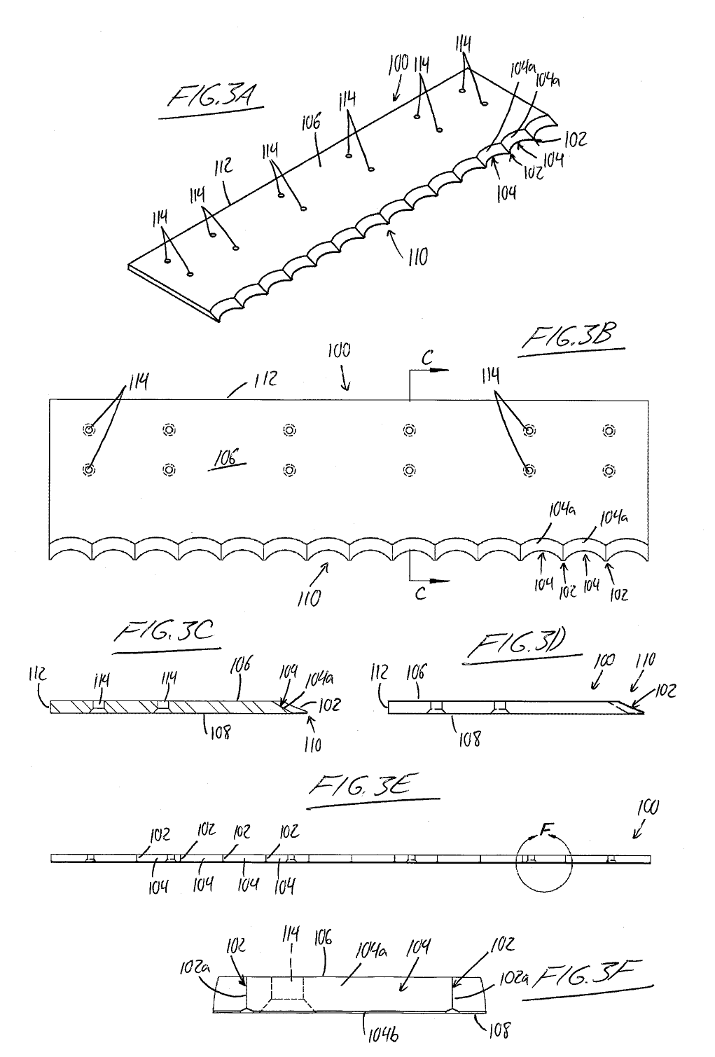

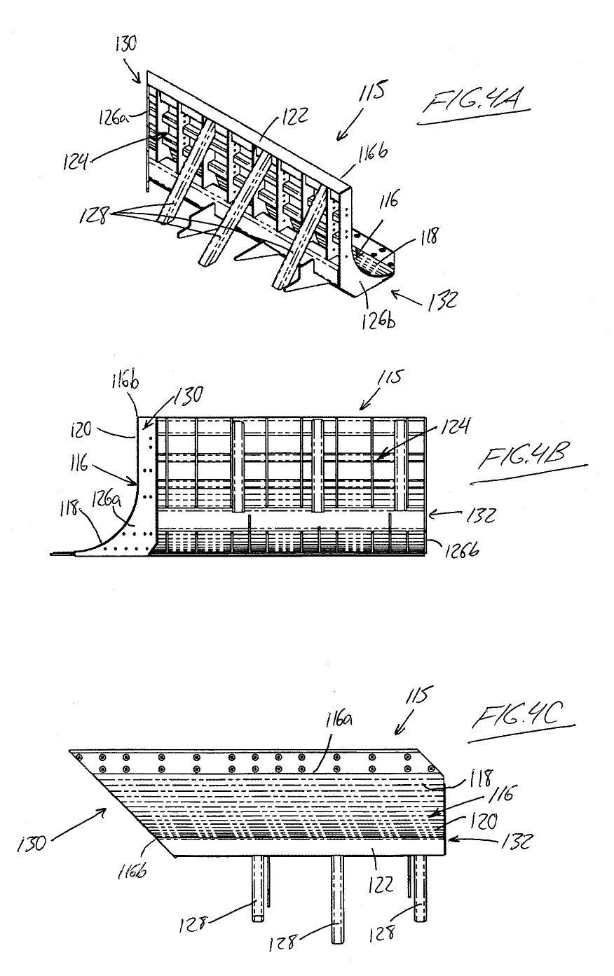

FIG. 3 illustrates a serrated cutting edge member 100 according to the present invention. The cutting edge member 100 is manufactured from a rectangular steel plate, which is machined to form serrations at one of its four perimeter edges, specifically at one of the two longer perimeter edges of the plate's elongated rectangular shape. The serration pattern features alternating crests 102 and troughs 104 running along this longitudinal perimeter edge of the cutting edge member 100. At each trough, the serrated edge has a concavely arcuate curvature of uniform radius spanning fully from the peak of one adjacent crest to the next. This concave curvature at each trough directly intersects the concave curvature of the neighbouring trough over a substantial majority of the cutting edge's height or thickness, which is measured perpendicularly between the planar topside 106 of the plate-shaped cutting edge member 100 and the opposing planar underside 106 that lies parallel to the topside.

The serrated cutting edge is chamfered from the topside 106 of the cutting edge member 100 toward the opposing underside 108 thereof, thus giving each trough a sloped face 104a that slopes obliquely outward from the plane of the flat topside 106. With reference to the close-up view of FIG. 3F, the sloped face 104a terminates a short distance upward from the underside 108 of the cutting edge member, leaving a thin unbeveled strip 104b of the trough 104 intact between the sloped face 104a and the underside 108 of the cutting edge member 100. This avoids a razor sharp point of a fully beveled cutting edge that might otherwise present a safety hazard during handling of the pre-fabricated cutting edge, for example during installation thereof during production or service of an implement suing the serrated cutting edge member. In the illustrated embodiment, based on a prototype cutting edge member with a 19.1 mm cutting edge height/thickness and a 1 mm unbeveled strip, the unbeveled strip 104b spans approximately five percent of the overall height or thickness of the cutting edge, though the unbeveled edge may vary, for example, from two to ten percent. In other embodiments, a full bevel may be employed, and require appropriate handling care and safety precautions. The concavely curved sloped face 104a of each trough 104 directly intersects the same concavely curved sloped face 104 of the next trough, thereby defining a linear ridge 102a of the crest 102 between these troughs over the substantial majority of the cutting edge height at the crest 102. With reference to the close-up view of FIG. 3F, each crest 102 also features a small tip face 102b residing beneath the linear ridge 102, where the outermost tip of the crest flattens out in a plane perpendicular to the underside of the cutting edge member and joins up with the unbeveled strips 104b at the bottom of the adjacent troughs. The peak of each crest (i.e. the area thereof reaching the furthest away from the opposing non-serrated elongated perimeter edge 112 of the cutting edge member) is thus has a relatively sharp peak over a substantial majority of the cutting edge height, and a flattened tip face of the distal end of the peak. While the opposing perimeter edge 112 in the illustrated embodiment is non-serrated, it may be serrated in other embodiments to provide a reversible cutting edge member than be removed and re-installed in a reverse orientation after wear or damage of the first serrated edge.

Between the serrated edge 110 and the opposing elongated perimeter edge 112 of the cutting edge member, a set of bolt holes 114 pass perpendicularly through the cutting edge member from the topside 106 thereof to the opposing underside 108 thereof. Each bolt hole 114 of the cutting edge member of the illustrated embodiment is countersunk at the underside 108 thereof.

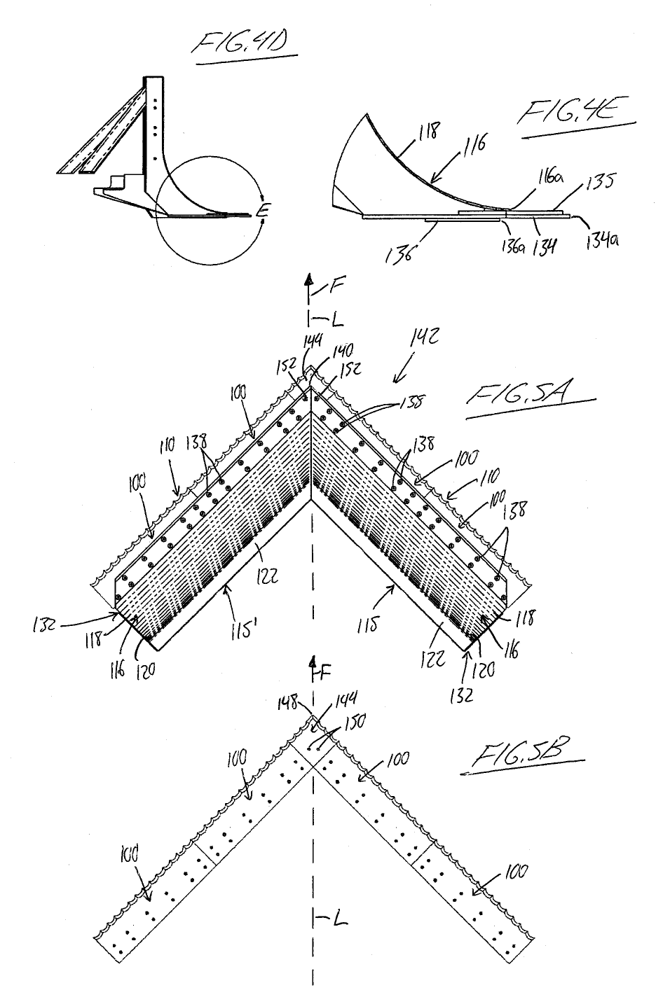

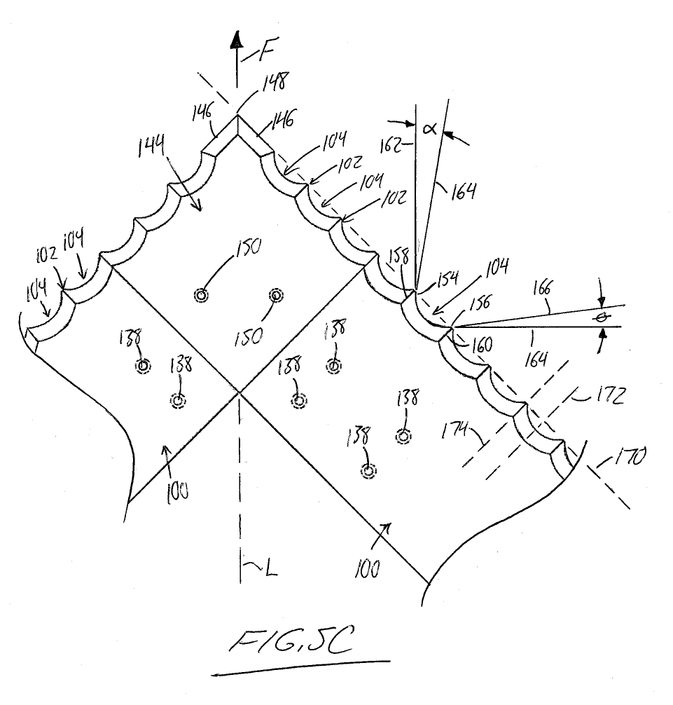

FIG. 4 illustrates a blade structure 115 on which cutting edge members of the type shown in FIG. 3 may be installed to form a serrated blade unit. Each blade structure features a curved clearing panel 116 that defines a face of the blade for clearing away trees and other vegetative material that is cut away from the earth by the cutting edge member of the assembled blade unit during use thereof.

The clearing panel 116 has a bottom edge 116a residing in a horizontal plane, from which a lower area 118 of the clearing panel curves upward in a concave manner and integrally transitions into a flat upper area 120 of the clearing panel that resides in a vertical plane and terminates at a horizontally oriented upper edge 116b of the clearing panel. Here, the top end of the blade structure is capped off by a top panel or plate 122, beneath which a reinforcement framework 124 featuring a grid-like array of reinforcement members is affixed to the backside of the clearing panel 116 to impart structural rigidity to the blade structure. End plates 126a, 126b cap off opposing ends of the reinforcement framework and clearing panel at opposing front and rear ends of the blade structure. Inclined braces 128 have upper ends thereof fixed to the reinforcement framework at the backside of the blade structure for use in attachment thereof to the frame of an implement on which the blade structure is to be installed.

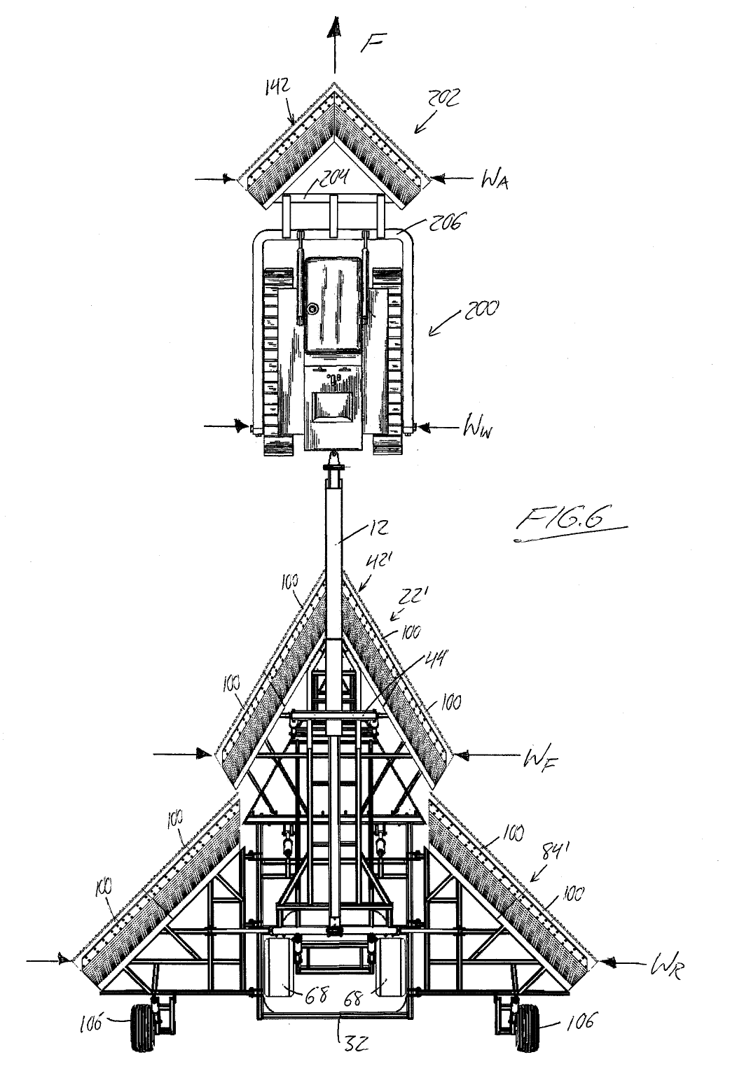

In FIG. 4, the clearing panel is tapered at one end thereof to form an angled front end 130 of the blade structure, where a second blade structure 115′ of mirroring form will have its likewise angled front end fitted against that of the first blade structure to form a V-shaped blade assembly in which the two blade structures diverge from a blade apex formed by their mating front ends, as shown in FIG. 5A. The opposing rear end 132 of the blade structure resides in a plane normal to the longitudinal direction of the blade (i.e. the direction in which the top of bottom edges of the clearing panel 116 extend), rather than in an angled plane oblique thereto like the angled front end 130. It will be appreciated that the angled front end is only necessary for front blade sections intended to reside at the front end of a two sided V-shape implement to form a blade apex where the front blade sections on the two sides of the implement frame rearwardly diverge. Other blade units situated further back on an implement frame need not have an angled front end, and may therefore instead employ a front end that lies perpendicular to the blade's longitudinal direction, like the illustrated and described rear end of the blade structure shown in FIG. 4.

With reference to FIGS. 4E, which shows the details of close-up circle E of FIG. 4D, a horizontal mounting plate 134 at the bottom of the blade structure is affixed in place to reside beneath the curved lower area 118 of the clearing panel 116 and to reach outwardly from thereunder past the bottom edge 116a thereof. A thickening plate 135 is affixed atop the mounting plate 134 in a positioned sandwiched between the topside of the mounting plate 134 and the bottom edge 116a of the clearing panel 116. The thickening plate 135 reaches both inwardly and outwardly from the bottom edge 116a of the clearing panel 116. The outer portion 136a of the thickening plate that resides beyond the bottom edge 116a of the clearing panel increases the effective thickness of the mounting plate. Threaded bolt holes 138 corresponding to the bolt holes 114 of the cutting edge member 100 pass vertically through the mounting and thickness plates 134, 135 at the outer portions thereof that reach beyond the bottom edge 116a of the clearing panel, and are laid out in the same pattern as the bolt holes 114 in the cutting edge member 100.

To install the cutting edge member on the blade structure, the topside 106 of the cutting edge member 100 is placed against the underside of the mounting plate 134 in a position aligning the bolt holes 114 of the cutting edge member 100 with the corresponding bolt holes 138 of the mounting and thickening plates 134, 135. Bolts are engaged upwardly into the mounting and thickening plates from beneath the cutting edge member in order to fasten the cutting edge member in place, while the bolt heads are accommodated by the countersunk bottom ends of the cutting member bolt holes 114 such that the installed bolts don't protrude downwardly beyond the flat underside 108 of the cutting edge member 100, but instead are flush with or recessed from said underside of the cutting edge member.

As part of the blade structure, an abutment plate 136 is affixed to the underside of the mounting plate 134 beneath the curved lower area 118 of the clearing panel 116 so as to reside at a spaced distance from the free end 134a of the mounting plate that is disposed outwardly beyond the bottom end 116a of the clearing panel 116. The edge 136a of the abutment plate facing outwardly toward the free end 134a of the mounting plate defines stop shoulder against which the non-serrated longitudinal edge 112 of the cutting edge member 100 is placed during installation. In the illustrated embodiment, each set of bolt holes 114, 138 features two parallel rows of bolt holes, each of which lies in a respective longitudinal plane of the cutting edge member or blade structure. The stop shoulder 136a is positioned such that abutment of the non-serrated longitudinal edge 112 of the cutting edge member 100 aligns the longitudinal plane of each row of bolt holes 114 in the cutting edge member 100 with the longitudinal plane of the corresponding row of bolt holes 138 in the mounting plate 134. Accordingly, the installer need only slide the cutting edge member longitudinally along the stop shoulder 136a in order to attain proper alignment between the two sets of bolt holes 114, 138.

FIG. 5A shows two blade structures (with the mounting braces 128 thereof omitted) having been fully equipped with cutting edge members 100 to form two finished blades that diverge from a blade apex 140 formed by mating together of the angled front ends 130 of the blade structures to form a V-shaped blade configuration 142. As shown, the number of bolt holes in the blade structures 115, 115′ may be an integer multiple of the number of holes in a single cutting edge member 100, whereby multiple cutting edges members 100 are required to form a serrated cutting edge over the full length of a single blade structure 115, 115′. The illustrated V-shaped blade configuration 142 further includes a front end cutting edge unit 144 mounted at the blade apex 140 to cooperate with the rectangular cutting edge members 100 to form extensions of the serrated edges thereof so that the resulting overall serrated cutting edge fully spans the front side of the V-shaped blade configuration.

As shown in FIG. 5B, the front cutting edge unit 144 is formed from a square plate, for example a steel plate of the same material and thickness as the cutting edge members 100, which has been machined to form serrations on two adjacent sides thereof. These serrations follow the same pattern as the cutting member serrations, thereby forming a continuous extension of this serration pattern. The front cutting edge unit 144 deviates from the serration pattern only at a leading tip thereof, where after the last crests, two linear segments 146 of the cutting edge converge together to form a point 148 at the leading tip of the cutting edge unit, which defines the forwardmost point of the completed V-shaped blade configuration. The front cutting edge unit 144 features another pair of bottom-countersunk bolt holes 150 passing through the planar topside and underside of the plate-shaped cutting edge unit 144. These bolt holes 150 align with a corresponding pair of threaded bolt holes 152 in the thickening and mounting plates of the blade structures 115, 115′ near the tips thereof at the tapered front ends of the mating blade structures 115, 115′.

When the V-shaped blade configuration 142 of FIG. 5A is installed on a towable implement, like that of FIGS. 1 and 2, the blade apex 140 lies on a central longitudinal axis of the towable implement, which thus bisects the diverging blades of the V-shaped blade configuration and which also denotes a forward working direction F in which the implement is conveyed when pulled by a suitable tow vehicle. The characteristics of the arcuately rounded troughs of the serration pattern, particularly the radius of curvature thereof and the angular span thereof (which together denote the size of the segment-shaped open trough-space between the crests) are selected in order provide a certain geometry of the trough shape relative to the forward working direction.

Turning to FIG. 5C, the concavely arcuate curvature at each trough 104 has a leading end 154 and a trailing end, of which the leading end 154 is nearer to the blade apex and thus leads the trailing end 156 in the forward working direction F. A leading crest 158 and trailing crest 160 likewise reside on opposite sides of each trough, whereby the leading end of the trough curvature joins up with the peak of the leading crest and the trailing end of the trough curvature joins up with the peak of the trailing crest.

In FIG. 5C, a longitudinal reference axis 162 extends forwardly from the leading end of one of the trough curvatures in a direction parallel to the forward working direction (and thus parallel to the central longitudinal axis L of the implement and its V-shaped blade configuration), and a leading end slope axis 164 is drawn to denote the slope of the leading end of the trough curvature relative to the longitudinal reference axis in a horizontal reference plane. In the illustration, the reference plane is a lower reference plane near the bottom of the cutting edge, i.e. at the plane of the unbeveled strip of the trough and the tip faces of the adjacent crests, as the reference axis and slope axis are drawn in relation to the concave curvature at the at these lower part of the cutting edge, not in relation to the concave curvature at the top of the cutting edge, where the curvature has a slightly greater angular span so as to directly intersect the curvature at the next trough at the ridged upper area of the crest peak.

The angle α between the longitudinal reference axis 162 and the leading end slope axis is between zero and fifteen degrees, thereby denoting that the slope of the leading end of the trough curvature is parallel, or nearly parallel, to the forward working direction F. In preferred embodiments, the angle α is less than fifteen degrees, in some embodiments twelve degrees or less, and in other embodiments ten degrees or less. In the illustrated embodiment, angle α at the tip-faced and unbeveled lower portion of the cutting edge is approximately ten degrees, measured on the same side of the longitudinal reference axis 162 as the trailing end of the same trough curvature (i.e. on the trailing side of the longitudinal reference axis 162). Angling of the leading end slope to this trailing side of the reference axis may be preferable over angling of the leading end slope to the opposing leading side of the reference axis, which may be more prone to breakage at the crests. If the leading end slope angle was instead measured at the top of the cutting edge in an upper reference plane, where the concave curvature extends to a linear ridge of each adjacent crest rather than only to a wider flattened tip face of the crest, then the angle would measure zero degrees in the illustrated embodiment, as the leading end slope at the top of the cutting blade is parallel to the forward working direction F.

Likewise, FIG. 5C features a lateral reference axis 166 drawn from the trailing end of one of the troughs in a direction perpendicular to the forward working direction (and thus perpendicular to the central longitudinal axis L of the implement and its V-shaped blade configuration), and a trailing end slope axis 168 is drawn to denote the slope of the trailing end of the trough curvature relative to the lateral reference axis in the horizontal reference plane. The angle θ between the lateral reference axis 162 and the trailing end slope axis is between zero and fifteen degrees, thereby denoting that the slope of the trailing end of the trough curvature is perpendicular, or nearly perpendicular, to the forward working direction F. In the illustrated embodiment, angle θ at tip-faced and unbeveled lower portion of the cutting edge is approximately ten degrees, measured on the same side thereof as the leading end of the same trough curvature (i.e. on the leading side of the lateral reference axis 164). With leading end slope parallel or nearly parallel to the forward working direction and the trailing end slope perpendicular or nearly perpendicular to the forward working direction, the leading end slope is thus more parallel to the forward working direction than the trailing end slope. While FIG. 5C shows the leading and trailing end slope for only a single trough, the other troughs share this same relationship between the leading and trailing end slopes and the forward working direction.

When a given serration (i.e. a given trough and its leading crest) is initially brought into contact with a tree trunk of greater radius than the trough radius, the first point of contact is at the leading crest of that serration. Since the slope of the concave trough curvature at the leading end thereof (i.e. at the leading crest of the given trough) is parallel or nearly parallel to the implement's travel in the forward working direction F, the cut starts off with very little aggression, as only a very small area of the cutting edge at this serration makes initial contact with the tree trunk. As the implement continues forward, the smooth curvature of the trough towards its trailing end of where its slope is most non-compliant with the blade's travel in the forward working direction causes a gradual increase in the contact area with the trunk as the blade advances therethrough, whereby the aggression of this serration's cutting action increases gradually over the full span of the serration. This provides for smooth, efficient travel of the implement during a vegetation clearing operation. In the illustrated embodiment, the crest tip faces of the cutting edge of each blade all lie on a singular oblique axis 170 oriented obliquely to the forward working direction in the lower horizontal reference plane, and being of uniform radius, the concave curvature at each trough is symmetric about a bisecting midline 172 that extends perpendicularly to the longitudinal dimension of the blade and resides centrally between the peaks of the adjacent crests on either side of the trough. The peak of each crest lies in a respective vertical plane 174 normal to the oblique axis, and thus parallel to the bisecting midline 172. The serration pattern is a repeating pattern of identical troughs and serrations, which thus have the same radius of curvature, same angular span, same leading end slope and same trailing end slope. In the illustrated embodiment, where the troughs and crests are both symmetric and the diverging blades are each angled at forty-five degrees to the forwarding working direction F, the slope lines of the leading and trailing ends of the trough curvature are likewise symmetric about the bisecting midline 172. In other blade geometries, for example a diverging blade configuration in which the two blades diverge from one another at 120-degrees so as to each lie at sixty degrees to the forward working direction, an arcuate trough curvature of uniform radius in a horizontal reference plane that is positioned to place the leading end of the curvature parallel or nearly parallel to the forward working direction will have a non-symmetrical slope at the trailing end, which therefore doesn't reside at the same angle to the perpendicular reference axis as the leading end to the longitudinal reference axis. Accordingly, the serration pattern of the present invention is not limited to use of blades that lie at 45-degrees to the forward working direction, and may be used on blades of other working angles, which may vary between 25-degrees and 75-degrees relative to the forward working direction of the implement. In addition, while the illustrated embodiment employs a circular trough curvature (i.e. curvature of uniform radius), other embodiments may employ other non-circular curves to provide the less-aggressive leading end slope and more-aggressive trailing end slope of the trough curvature, particularly where blade angles other than 45-degrees are employed. For a 45-degree blade angle, a quarter-circle curvature (90-degree arc) can be used to accomplish leading and trailing end curvature slopes lying parallel and perpendicular to the forward working direction, respectively. However, as disclosed for the illustrated embodiment, a slightly less than 90-degree arc may be used at the lower reference plane to provide nearly, but not entirely, parallel and perpendicular slopes while truncating the lower ends of the crest peaks to better prevent tip breakage that might occur with sharper pointed tips at the bottom ends of the crest peaks.

Having described the unique blades of the present invention, attention is now turned to their use, and example of which is shown in FIG. 6, where a bulldozer or other working machine 200 is used as a tow vehicle for a towed implement 10′ that is similar to that of FIGS. 1 and 2, but is equipped with the above-described blades of the present invention. The working machine 200 is equipped with an attachment implement 202 featuring a frame 204 that carries a V-shaped blade configuration 42 of the present invention and is configured for suitable attachment to a lift arrangement 206 of the working machine at the front end thereof so as to lead the working machine 200 when driven in the forward working direction F. Suitable framework and connections for supporting blades on the front end lift arrangement of bulldozers and other working machines are well known in the art, and therefore are not described herein in further detail. The lift arrangement 206 of the working machine is operable in a known manner to raise and lower the attachment implement about a horizontal pivot axis on the working machine, whereby an operator of the tow vehicle 200 can lower the lift arrangement into a lowered condition placing the serrated cutting edges of the V-shaped blade configuration 142 in horizontal working positions parallel to the ground in close proximity thereover. Driving of the working machine 200 in the forward working direction F will therefore cause the serrated edges to cut tree trunks and other vegetative stalks or material free from the earth at or near ground level, while the clearing panels 116 of the diverging blades will clear any such cut material laterally outward out of the travel path of the working machine 200. For this purpose, the working width W_{A} of the attachment implement measured perpendicularly to the forward working direction at the rear ends of the serrated cutting edges of the diverging blade configuration exceeds the width of the working machine W_{W}.

The pull tongue 12 of the towed implement 10′ is coupled to a suitable hitch at the rear of the working machine 200 so as to trail the working machine in the shadow thereof. The central longitudinal axis of the towed implement aligns with those of the working machine 200 and the V-shaped blade configuration of the attachment implement 202 when the working machine 200 is driven straight in the forward working direction F. The towed implement features diverging front blade sections 22′ assembled from the blade structures, cutting edge members and front cutting edge unit described herein above, and as shown, may include multiple blade structures on each side of the front frame section of the towed implement. The front blade sections 22′ are affixed to the front frame section in stationary positions. Rear blade sections 84′ movably carried by the raisable/lowerable sub-frames 82 at the rear frame section of the towed implement are likewise assembled from the blade structures and cutting edge members described herein above. While the figure shows the front and rear blade sections diverging at different angles, with the front blade sections diverging from one another at sixty degrees so as lie at thirty degrees to the forward working direction F and the rear blade sections diverging at a greater angle of ninety degrees so as to lie at 45-degrees to the forward working direction, it will be appreciated that the front and rear blades may alternatively be configured to diverge at the same angle.

To prepare the towed implement for use, the main ground wheels 68 of the towed implement 10 are adjusted to lower the leading front end of the towed implement frame 14 into a lowered position placing the serrated cutting edges of the V-shaped blade configuration 142′ at the front of the towed implement frame 14 in the same horizontal working positions as the serrated cutting edges of the attachment implement 202. The rear sub-frames 82 of the towed implement 10′ are lowered into their deployed positions to likewise place the serrated cutting edges of the rear blade sections 84′ into lowered working positions horizontally adjacent the ground surface in close proximity thereto. The outboard wheels 106 can be adjusted in position by their respective actuators to fine tune the working positions of the rear blade sections 84′.

The working width W_{F} of the front blade sections 22′ of the towed implement 10′, measured perpendicularly to the forward working direction F at the rear ends of the serrated cutting edges of the front blade sections 22′, exceeds the width of the working machine W_{W}, and also exceeds the working width W_{A} of the attachment implement 202. Accordingly, towing of the towed implement 10′ by the working machine 200 increases the area of land that is cleared of vegetation in a single pass of the working machine over a swath of land, even if the rear sub-frames are stowed in their raised positions. Accordingly, if the desired swath of land to be cleared is greater than the working width W_{A} of the attachment implement 202, but less than the larger working width W_{R} of the rear blade sections 84′, as measured perpendicularly to the forward working direction F at the rear ends of the serrated cutting edges of the rear blade sections 84′ in the lowered working positions thereof, the towed implement can be used with the rear blade sections stowed. However, the large scale towed implement is best suited for clearing wide swaths of land, as the deployed rear blade sections 84′ provide a working width W_{R} that is dramatically greater than attachment implements of the prior art. For example, the rear working width W_{R} may be equal to or greater than 30 feet in some embodiments, and equal to or greater than 50 feet in other embodiments.

In a clearing operation intended to clear a swath of land whose width exceeds the maximum working width of the towed implement, as determined by the rear working width W_{R} in the case of a multi-section implement with selectively deployable rear blades, a first pass over the land is performed by driving the working machine 200 forwardly thereover to effectively clear a first strip of land whose width is generally equal to the overall working width W_{R} of the towed implement. A second pass is then performed in order to clear an additional strip beside the first now-cleared strip.

To ensure suitable overlap with the first strip and thereby minimize the opportunity for uncleared spots at the boundary between two sequential and adjacent passes, the machine operator may drive the working machine forwardly through the first now-cleared strip of land in close proximity to the border of the second strip being cleared. During this second pass, only the towed implement, and more specifically only the one side of the towed implement that reaches laterally out into the second strip of land, is working to clear the vegetation from this second strip of land. Even when the attachment implement on the working machine is only used in the first pass, with only the towed implement working in subsequent passes, the working half of the towed implement may exceed the working width of the attachment implement for large scale embodiments of the towed implement, meaning that the towed implement not only increases the width of the first pass, but also the width of each additional pass.

Alternatively, rather than driving the working machine through the area cleared in the first pass, the second pass may instead be performed by once again driving the working machine through a previously uncleared area, in which case the second pass uses the full width of the towed implement. However, using the previously cleared area in the second pass reduces the overall performance load on the working machine both by reducing the cutting load and providing easier terrain to traverse in the second pass and any additional passes subsequent thereto. During the first pass, or any other full-width passes, a second bulldozer or other working machine may be driven in a trailing position behind the towed-implement and be used to push forwardly on the rear end 14b of the towed implement frame in the event of heavy clearing operations that would benefit from additional motive force for the towed implement. A standard blade, bucket or other front end attachment of this rear end working machine, or pushing vehicle, may exert a pushing force against a rear-most cross member 32 spanning between the parallel side rails 70 of the rear frame section of the towed implement behind the main ground wheels 68 to define the rear end of the towed implement frame.

In addition to the uniquely serrated cutting edges described herein above, the vertically oriented upper end of the blade structures herein also differ from conventional blade design and offer advantage over same. Prior art blades feature forwardly inclined blade face area or forwardly inclined guides or deflectors at the upper ends of the blades. However, this forward inclination at the top of the blade introduces area by which cut material that is displaced upwardly as it is freed from the earth exerts upward force of the blade, thereby tending to the lift the serrated cutting edge upwardly out of its optimal position close to the ground surface to minimize remnant material protruding above ground level after the clearing operation. Applicant's lack of forwardly inclined features at the top of the blade structure prevents such undesirable lifting action on the blade.

While the illustrated embodiments describe use of the unique serrated cutting edges of the present invention on large-scale, double sided (V-shaped) implements, the same advantageous cutting edges may likewise be used on smaller implements, and on implements lacking a V-shaped blade configuration and instead carrying one or more blades angled in only one direction relative to the forward working direction. Likewise, while the illustrated embodiment employs bolted attachment of the serrated cutting edges to separate blade structures defining the remainder of the blade, thereby allowing easy removal replacement of damaged blades, other attachment methods may be employed, including permanent attachment by welding or other means.

Since various modifications can be made in my invention as herein above described, and many apparently widely different embodiments of same made within the scope of the claims without departure from such scope, it is intended that all matter contained in the accompanying specification shall be interpreted as illustrative only and not in a limiting sense.

1. A vegetation clearing implement comprising:
at least one blade arranged for conveyance over an area of land in a forward working direction and each comprising a respective serrated cutting edge positioned at a leading side of the blade to ride over the ground area in close relation thereto, the serrated cutting edge of each blade lying along an oblique axis that resides at an oblique angle relative to said forward working direction;
wherein the serrated cutting edge comprises alternating crests and troughs situated along the oblique axis and has a concave curvature at each trough disposed between a pair of adjacent crests, the concave curvature has a leading end that joins to a leading one of said adjacent crests and a trailing end that joins to a trailing one of said adjacent crests, a slope of the concave curvature is more parallel to the forward working direction at the leading end than at the trailing end, and the slope of the concave curvature at the leading end is within fifteen degrees of parallel to the forward working direction.

2. The vegetation clearing implement of claim 1 wherein the concave curvature spans peak to peak from said leading crest to said trailing crest.

3. The vegetation clearing implement of claim 1 wherein the slope at the trailing end of the concave curvature is within fifteen degrees of perpendicular to the forward working direction.

4. The vegetation clearing implement of claim 1 wherein, relative to a respective longitudinal reference axis that is parallel to the forward working direction and intersects the leading end of the concave curvature at any trough, the slope of the leading end of the concave curvature at said trough is sloped at an acutely oblique angle to said reference axis on a same side thereof as the trailing end of the concave curvature of said trough.

5. The vegetation clearing implement of claim 1 wherein, relative to a lateral reference axis that is perpendicular to the forward working direction and intersects the trailing end of the concave curvature at any trough, the slope of the trailing end of the concave curvature at said trough is sloped at an acutely oblique angle to said lateral reference axis on a same side thereof as the leading end of the concave curvature at said trough.

6. The vegetation clearing implement of claim 1 wherein the concave curvature at each trough of the serration pattern is arcuate in shape.

7. The vegetation clearing implement of claim 1 wherein the concave curvature of each trough of the serration pattern is uniform in radius.

8. The vegetation clearing implement of claim 1 wherein each trough of the serration pattern is symmetric about a bisecting midline that resides centrally between the peaks of the adjacent crests.

9. The vegetation clearing implement of claim 1 wherein the cutting edge comprises a chamfer at the troughs and the crests, said chamfer leaving an unbeveled strip at a bottom of each trough.

10. The vegetation clearing implement claim 1 wherein each blade has a curved lower portion which curves upwardly away from the cutting edge and an upper portion spanning upward from the curved lower portion to a top end of the blade, and the upper portion, on the leading side of the blade, is free of any inclination toward said leading side of the blade.

11. The vegetation clearing implement of claim 10 wherein the upper portion of each blade is vertically oriented.

12. The vegetation clearing implement of claim 10 wherein each blade comprises a clearing panel that defines a face of the blade and has a curved lower area at the lower portion of the blade and a flat upper area that resides at the upper portion of the blade and reaches the top end thereof.

13. The vegetation clearing implement of claim 1 wherein the serrated cutting edge of each blade is at least partially defined by a cutting edge member bolted to a remainder of the blade via a set of bolt holes provided in the cutting member in positions trailing the serrated cutting edge.

14. The vegetation clearing implement of claim 1 wherein the serrated cutting edge of each blade is at least partially defined by a respective cutting edge member bolted to a remainder of the blade via a set of bolt holes provided in the cutting member in positions trailing the serrated cutting edge, and the remainder of each blade comprises a clearing panel that defines a face of the blade and has a curved lower area at the lower portion of the blade, and a mounting plate affixed to the curved lower end of the clearing panel and having a corresponding set of bolt holes therein by which the cutting edge member is bolted to the mounting plate.

15. The vegetation clearing implement of claim 14 wherein the cutting edge member is bolted to an underside of the mounting plate, and a trailing edge of the cutting member abuts against a stop shoulder that is situated behind the corresponding set of bolt holes in the mounting plate and serves to align the bolt holes of the cutting edge member with the corresponding set of bolt holes in the mounting plate.

16. The vegetation clearing implement of claim 1 wherein the at least one blade comprises a pair of diverging blades that meet at an apex at a leading end of the implement, and the serrated cutting edges of the pair of diverging blades are partially defined by respective cutting edge members that terminate short of one another at the apex and partially defined by a separate front cutting edge unit that is mounted between the cutting edge members at the apex, the front cutting edge unit having serrations on adjacent diverging sides thereof that meet at a leading tip of said front cutting edge and align with corresponding serrations on the cutting edge members so that the serrations of the cutting edge unit and the corresponding serrations of the cutting edge members collectively define the serrated cutting edges of the diverging blades.

17. The vegetation clearing implement of claim 1 wherein each crest of the serration pattern is bisected by a respective bisection axis that lies perpendicular to the oblique axis.

18. The vegetation clearing implement of claim 1 wherein the peak of each crest of the serration pattern has a ridge at which sloped faces of adjacent troughs on opposite sides of said crest directly intersect, and a flat lower tip face that resides beneath the upper ridge and tapers upwardly theretoward.

19. A vegetation clearing implement comprising:
at least one blade arranged for conveyance over an area of land in a forward working direction and each comprising a respective serrated cutting edge positioned at a leading side of the blade to ride over the ground area in close relation thereto, the serrated cutting edge of each blade lying along an oblique axis that resides at an oblique angle relative to said forward working direction;
wherein the serrated cutting edge comprises alternating crests and troughs situated along the oblique axis, and at each trough disposed between a pair of adjacent crests, the serrated cutting edge follows a concave curvature spanning peak to peak from one of said adjacent crests to the other.

20. A vegetation clearing implement comprising:
at least one blade comprising:
a cutting edge member having a cutting edge and a set of bolt holes passing through the cutting member at an area thereof between the cutting edge and an opposing perimeter edge of the cutting edge member;
a clearing panel that defines a face of the blade and has a curved lower area curving upwardly away from the cutting edge member at a lower portion of the blade; and
a mounting plate affixed to the curved lower end of the clearing panel and having a corresponding set of bolt holes therein by which the cutting edge member is bolted to the mounting plate in a position placing the cutting edge of the cutting edge member outwardly beyond both the mounting plate and the curved lower area of the clearing panel on a leading side of the panel faced by a concave side of the curved lower area of the clearing panel.

21. A vegetation clearing implement comprising:
at least one blade comprising:
a cutting edge mounted at a lower portion of the blade on a leading side thereof for riding over the ground in close proximity thereto;
a curved lower portion which curves upwardly away from the cutting edge with a concave side of the curved lower portion facing said leading side of the blade; and
an upper portion spanning upward from the curved lower portion to a top end of the blade;
wherein the upper portion of the blade, on the lead siding thereof, is free of any inclination toward said leading side of the blade.
